(19) United States
(12) Patent Application Publication
(10) Pub. No.: US 2010/0316293 A1
(43) Pub. Date: Dec. 16, 2010

(54) SYSTEM AND METHOD FOR SIGNATURE EXTRACTION USING MUTUAL INTERDEPENDENCE ANALYSIS

(75) Inventors: Heiko Claussen, Plainsboro, NJ (US); Justinian Rosca, West Windsor, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Corporation, Iselin, NJ (US)

(21) Appl. No.: 12/614,625

(22) Filed: Nov. 9, 2009

Related U.S. Application Data
(60) Provisional application No. 61/186,932, filed on Jun. 15, 2009.

(51) Int. Cl. G06T 7/00

(52) U.S. Cl. 382/170

(57) ABSTRACT

A method for determining a signature vector of a high dimensional dataset includes initializing a mutual interdependence vector w_{GMIA} from a a set X of N input vectors of dimension D, where N≦D, randomly selecting a subset S of n vectors from set X, where n is such that n>>1 and n<N, calculating an updated mutual interdependence vector w_{GMIA} from

w_{GMIA}_{_{—}}_{new}=w_{GMIA}+S·(S^{T}·S+βI)⁻¹·( 1̅−M^{T}·w_{GMIA}),

where β is a regularization parameter,

$${M}_{ij} = \frac{{S}_{ij}}{\sqrt{{\sum }_{k} {S}_{kj }^{2}}} ,$$

I is an identity matrix, and 1̅ is a vector of ones, and repeating the steps of randomly selecting a subset S from set X, and calculating an updated mutual interdependence vector until convergence, where the mutual interdependence vector is approximately equally correlated with all input vectors X.

### CROSS REFERENCE TO RELATED UNITED STATES APPLICATIONS

This application claims priority from “Properties of Mutual Interdependence Analysis”, U.S. Provisional Application No. 61/186,932 of Rosca, et al., filed Jun. 15, 2009, the contents of which are herein incorporated by reference in their entirety.

### TECHNICAL FIELD

This disclosure is directed to methods of statistical signal and image processing.

### DISCUSSION OF THE RELATED ART

The mean of a data set is one trivial representation of data from one class that can be used in classification or identification problems. Statistical signal processing methods such as Fisher's linear discriminant analysis (FLDA), canonical correlation analysis (CCA), or ridge regression, aim to model or extract the essence of a dataset. The goal is to find a simplified data representation that retains the information that is necessary for subsequent tasks such as classification or prediction. Each of the methods uses a different viewpoint and criteria to find this “optimal” representation. Furthermore, pattern recognition problems implicitly assume that the number of observations is usually much higher than the dimensionality of each observation. This allows one to study characteristics of the distributional observations and design proper discriminant functions for classification. For example, FLDA is used to reduce the dimensionality of a dataset by projecting future data points on a space that maximizes the quotient of the between- and within-class scatter of the training data. In this way, FLDA aims to find a simplified data representation that retains the discriminant characteristics for classification. CCA can be used for classification of one dataset if the second represents class label information. Thus, directions are found that maximally retain the labeling structure. On the other hand, CCA assumes one common source in two datasets. The dimensionality of the data is reduced by retaining the space that is spanned by pairs of projecting directions in which the datasets are maximally correlated. In contrast to this, ridge regression finds a linear combination of the inputs that best tits a known optimal response. To learn a to ridge regression based classifier, the class labels are used as optimal system responses. This approach can suffer for a large number of classes.

Recently, mutual interdependence analysis (MIA) has been successfully used to extract more involved representations, or “mutual features”, to accounting for samples in a class. For example, a mutual feature is a speaker signature under varying channel conditions or a face signature under varying illumination conditions. A mutual representation is a linear regression that is equally correlated with all samples of the input class.

### SUMMARY OF THE INVENTION

Exemplary embodiments of the invention as described herein generally include methods and systems for computing a unique invariant or characteristic of a dataset that can be used in class recognition tasks. An invariant representation of high dimensional instances can be extracted from a single class using mutual interdependence analysis (MIA). An invariant is a property of the input data that does not change within its class. By definition, the MIA representation is a linear combination of class examples that has equal correlation with all training samples in the class. An equivalent view is to find a direction to project the dataset such that projection lengths are maximally correlated. An MIA optimization criterion can be formulated from the perspectives of regression, canonical correlation analysis and Bayesian estimation, to state and solve the criterion concisely, to contrast the unique MIA solution to the sample mean, and to infer other properties of its closed form solution under various statistical assumptions. Furthermore, a general MIA solution (GMIA) is defined. It is shown that GMIA finds a signal component that is not captured by signal processing methods such as PCA and ICA.

Simulations are presented that demonstrate when and how MIA and GMIA represent an invariant feature in the inputs, and when this diverges from the mean of the data. Pattern recognition performance using MIA and GMIA is demonstrated on both text-independent speaker verification and illumination-independent face recognition applications. MIA and GMIA based methods are found to be competitive to contemporary algorithms.

According to an aspect of the invention, there is provided a method for determining a signature vector of a high dimensional dataset, the method including initializing a mutual interdependence vector w_{GMIA} from a a set X of N input vectors of dimension D, where N≦D, randomly selecting a subset S of n vectors from set X, where n is such that n>>1 and n<N, calculating an updated mutual interdependence vector w_{GMIA} from w_{GMIA}_{_{—}}_{new}=w_{GMIA}+S·(S^{T}·S+βI)⁻¹·( 1̅−M^{T}·w_{GMIA}), where β is a regularization parameter,

$${M}_{ij} = \frac{{S}_{ij}}{\sqrt{{\sum }_{k} {S}_{kj}^{2}}} ,$$

I is an identity matrix, and 1̅ is a vector of ones, and repeating the steps of randomly selecting a subset S from set X, and calculating an updated mutual interdependence vector until convergence, where the mutual interdependence vector is approximately equally correlated with all input vectors X.

According to a further aspect of the invention, the mutual interdependence vector converges when 1−|w_{GMIA}_{_{—}}_{new}^{T}·w_{GMIA}|<δ, where δ<<1 is a very small positive number.

According to a further aspect of the invention, the method includes estimating the regularization parameter β by initializing β to a very small positive number βᵢ<<1, and repeating the steps of setting w_{GMIA}_{_{—}}_{S}=S·(S^{T}·S+βᵢI)⁻¹· 1̅, and calculating an updated βᵢ₊₁, until |βᵢ₊₁−βᵢ|<ε where ε<<1 is a positive number.

According to a further aspect of the invention,

$${β}_{i + 1} = \frac{{\vert \overline{1} - {w}_{GMIA \_ S} \vert}^{2}}{{\vert \overline{1} - {S}^{T} \cdot {w}_{GMIA \_ S} \vert}^{2}} .$$

According to a further aspect of the invention, the mutual interdependence vector w_{GMIA} is initialized as

$${w}_{GMIA} = \frac{X ( : , 1 )}{\vert X ( : , 1 ) \vert} ,$$

where X (:,1) is a first vector in the set X.

According to a further aspect of the invention, the method includes normalizing

$${w}_{GMIA} as \frac{{w}_{GMIA} }{\vert {w}_{GMIA} \vert} .$$

According to a further aspect of the invention, the D-dimensional set X of input vectors is a set of signals of a class, and the mutual interdependence vector w_{GMIA} represents a class signature.

According to a further aspect of the invention, the class is one of an audio signal representing one person, an acoustic or vibration signal representing a device or phenomenon, or a one-dimensional signal representing a quantization of a physical or biological process.

According to a further aspect of the invention, the method includes processing the signal inputs to a domain where resulting signals fit a linear model xᵢ=aᵢs+fᵢ+nᵢ, to where i=1, . . . , N, s is a common, invariant component to be extracted from the signals, αᵢ are predetermined scalars, fᵢ are combinations of basis functions selected from an orthogonal dictionary where any two basis functions are orthogonal, and nᵢ are Gaussian noises.

According to a further aspect of the invention, the D-dimensional set X of input vectors is a set of two-dimensional signals, under varying illumination conditions, and the mutual interdependence vector w_{GMIA} represents a class signature.

According to another aspect of the invention, there is provided a program storage device readable by a computer, tangibly embodying a program of instructions executable by the computer to perform the method steps for determining a signature vector of a high dimensional dataset.

According to another aspect of the invention, there is provided a method for determining a signature vector of a high dimensional dataset, the method including providing a set of N input vectors X of dimension D, X∈R^{D×N}, where N<D, calculating a mutual interdependence vector w_{GMIA} that is approximately equally correlated with all input vectors X from

$$\begin{matrix}{w}_{GMIA} = {μ}_{w} + {C}_{w} \cdot X \cdot {( {X}^{T} \cdot {C}_{w} \cdot X + {C}_{n} )}^{- 1} \cdot ( r - {X}^{T} \cdot {μ}_{w} ) , \\ = {μ}_{w} + {( X \cdot {C}_{n}^{- 1} \cdot {X}^{T} + {C}_{w}^{- 1} )}^{- 1} \cdot X \cdot {C}_{n}^{- 1} \cdot ( r - {X}^{T} \cdot {μ}_{w} ) ,\end{matrix}$$

where r is a vector of observed projections of inputs x on w where r=X^{T}·w+n, n is a Gaussian measurement noise, with 0 mean and covariance matrix Cₙ, w is a Gaussian distributed random variable with mean μ_{w} and covariance matrix Cₙ and w and n are statistically independent.

According to a further aspect of the invention, the method includes iteratively computing μ_{w} as an approximation to w_{GMIA} using subsets S of the set X of input vectors.

### BRIEF DESCRIPTION OF THE DRAWINGS

FIG. 1 is a flowchart of a method for extracting an invariant representation of high dimensional data from a single class using mutual interdependence analysis (MIA), according to an embodiment of the invention.

FIG. 2 is a set of graphs of comparison results using various signal processing methods, according to an embodiment of the invention.

FIGS. 3(a)-(c) graphically compare the extraction performance of a common component using MIA, GMIA and the mean, according to an embodiment of the invention.

FIGS. 4(a)-(b) illustrates the structure of voiced versus unvoiced sounds, according to an embodiment of the invention.

FIGS. 5(a)-(f) is a set of graphs depicting the processing and feature extraction chain for text-independent speaker verification using GMIA, according to an embodiment of the invention.

FIGS. 6(a)-(b) are graphs comparing speaker verification results using GMIA and mean features, according to an embodiment of the invention.

FIG. 7 is Table 1, a set MIA and GMIA performance comparison results using various NTIMIT database segments, according to an embodiment of the invention.

FIG. 8 shows the set of basis functions for the first person, A, of the YaleB database, according to an embodiment of the invention.

FIGS. 9(a)-(b) shows images used for testing, according to an embodiment of the invention.

FIGS. 10(a)-(b) depict results of synthetic MIA experiments with various illumination conditions, according to an embodiment of the invention.

FIGS. 11(a)-(b) depict the image set of one individual in the Yale database and the MIA result estimated from all images of the set, according to an embodiment of the invention.

FIGS. 12(a)-(c) depicts examples of training instances used in Eigenfaces, Fisherfaces and MIA, according to an embodiment of the invention.

FIG. 13 depicts an extraction process of the mutual image representation, according to an embodiment of the invention.

FIG. 14 shows Table 2, a comparison of the identification error rate (IER) of MIA with other methods using the Yale database, according to an embodiment of the invention.

FIG. 15 is a block diagram of an exemplary computer system for implementing a method for extracting an invariant representation of high dimensional data from a single class using mutual interdependence analysis (MIA), according to an embodiment of the invention.

### DETAILED DESCRIPTION OF EXEMPLARY EMBODIMENTS

Exemplary embodiments of the invention as described herein generally include systems and methods for extracting an invariant representation of high dimensional data from a single class using mutual interdependence analysis (MIA). Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

### Mutual Interdependence Analysis

Throughout this disclosure, xᵢ^{(p)}∈ [symbol] ^{D} denotes the i^{th} input vector, i=1, . . . , N^{(p)} in class p. Furthermore, X₍ₚ₎ [symbol] X represents a matrix with columns xᵢ^{(p)} and X denotes the matrix with columns xᵢ, of all classes K. Moreover,

$$μ = \frac{1}{N} {\sum }_{i = 1}^{N} {x}_{i} ,$$

1̅ is a vector of ones and I represents the identity matrix. The remaining notation will be clear from the context.

Assume that one desires to find a class representation w^{(p)} of high dimensional data vectors xᵢ^{(p)} (D≧N^{(p)}). A common first step is to select features and reduce the dimensionality of the data. However, because of possible loss of information, this preprocessing is not always desirable. Therefore, it is desirable to find a class representation of similar or same dimensionality as the input.

The quality of such a representation can be evaluated by its correlation with the class instances. A superior class representation should be highly correlated and also should have a small variance of the correlations over all instances in the class. The former condition ensures that most of the signal energy in the samples is captured. The latter condition is indicative of membership in a single class. Note that only vectors in the span of the class vectors contribute to the cross-correlation value. Therefore, in the absence of prior knowledge, it is reasonable to constrain the search for a class representation w to the span of the training vectors w=X^{(p)}·c, where c∈ [symbol] ^{N}.

The MIA representation of a class p is defined as a direction w_{MIA}^{(p)} that minimizes the projection scatter of the class p inputs, under the linearity constraint to be in the span of X^{(p)}:

$${w}_{MIA}^{( p )} = {argmin}_{w \cdot w = X ( p ) \cdot c} ( {w}^{T} \cdot ( {X}^{( p )} - {μ}^{( p )} \cdot {\overline{1}}^{T} ) ) ( ( {X}^{( p )} - {μ}^{( p )} \cdot {\overline{1}}^{T} ) \cdot w ) . \qquad ( 1 )$$

Note that the original space of the inputs spans the mean subtracted space plus possibly one additional dimension. Indeed, the mean subtracted inputs, which are linear combinations of the original inputs, sum up to zero. Mean subtraction cancels linear to independence resulting in a one dimensional span reduction.

Theorem 2.1 The minimum of the criterion in EQ. (1) is zero if the inputs xᵢ are linearly independent.

If inputs are linearly independent and span a space of dimensionality N≦D, then the subspace of the mean subtracted inputs in EQ. (1) has dimensionality N−1. There exists an additional dimension in R^{N}, orthogonal to this subspace. Thus, the scatter of the mean subtracted inputs can be made zero. The existence of a solution where the criterion in EQ. (1) becomes zero is indicative of an invariance property of the data.

Theorem 2.2 The solution of EQ. (1) is unique (up to scaling) if the inputs xᵢ are linearly independent.

By solving in the span of the original rather than the mean subtracted inputs, a closed form solution of EQ. (1) can be found:

w_{MIA}^{(p)}=ζX^{(p)}·(X^{(p)T}·X^{(p)})⁻¹· 1̅, where ζ is a constant. (2)

Consider that (X^{(p)T}·X^{(p)})⁻¹· 1̅ is a column vector. The structure of the solution shows that w is a data-dependent transformation representing a linear combination of the input observations. The mathematical structure of this MIA solution is similar to linear regression. Indeed, this result can be obtained as follows. Assume a regression y=x·β, and look for a β such that the unknown regression y is equally correlated with all inputs: X^{T}·y= 1̅. It can be shown that the solution to this regression is given by EQ. (2) with ζ=1 and y=w. It will be shown below which assumptions distinguish the two approaches. The uniqueness of the MIA criterion EQ. (1) indicates that it captures an inherent property of the input data. Next it will be shown that this is indeed an invariant provided that the inputs are from one class.

### Canonical Correlation Analysis

If a common source s∈ [symbol] ^{N} influences two datasets X∈ [symbol] ^{D×N} and Z∈ [symbol] ^{K×N} of possibly different dimensionality, canonical correlation analysis (CCA) can be used to extract this inherent similarity. The goal of CCA is to find two vectors into which to project the datasets such that their projection lengths are maximally correlated. Let C×Z denote the cross covariance matrix between the datasets X and Z. Then the CCA task is given by maximization of the objective function:

$$J ( a , b ) = \frac{{a}^{T} \cdot {C}_{XZ} \cdot b}{\sqrt{{a}^{T} \cdot {C}_{XX} \cdot a} \sqrt{{b}^{T} \cdot {C}_{ZZ} \cdot b}} \qquad ( 5 )$$

over the vectors a and b. The CCA task can be solved by a singular eigenvector decomposition (SVD) of C_{XX}^{-1/2}·C_{XZ}·C_{ZZ}^{-1/2}. This SVD can be solved by the two simple eigenvector equations:

(C_{XX}^{-1/2}·C_{XZ}·C_{ZZ}⁻¹·C_{ZX}·C_{XX}^{-1/2})·a=λ·a, (6)

and

(C_{ZZ}^{-1/2}·C_{ZX}·C_{XX}⁻¹·C_{XZ}·C_{ZZ}^{-1/2})·b=λ·b. (7)

The intuition is that the maximally correlated projections XI.a and Z7.b represent an estimate of the common source.

Canonical correlation analysis can be used to extract classification relevant information from a set of inputs. Let X be the union of all data points and Z the table of corresponding class memberships, k=1, . . . , K and i=1, . . . , N:

$${Z}_{ki} = \{ \begin{matrix}1 , & if {x}_{i} ∈ {X}^{( k )} , \\ 0 , & otherwise .\end{matrix}$$

The intuition is that all classification relevant information is represented by the classification table. Therefore, this information is retained in those input components of X that originate from a common virtual source with the classification table. All classification relevant information is represented by this classification table. Therefore, this information is retained in those input components of X that originate from a common virtual source with the classification table.

### Alternative MIA Criterion

The formulation of the CCA equations can be modified to extract an invariant signal from inputs of a single class. One interpretation of CCA is from the point of view of the cosine angle between the (non mean subtracted) vectors a^{T}·X and Z^{T}·b. The aim is to find a vector pair that results in a minimum angle. Hence, rather than using the mean subtracted covariance matrices, the original inputs X^{(p)} are used. In this single class case, the classification table Z degenerates to a vector that is a single row of ones, and b to a scalar. This maximization criterion becomes invariant to b because of the scaling invariance of CCA and the special form of Z. Therefore, one can replace Z^{T}·b by 1̅·b. Thus, the modified CCA (MCCA) equation is given by:

$${\hat{a}}_{MCCA} = {argmax}_{a} \frac{{a}^{T} \cdot {X}^{( p )} \cdot \overline{1}}{\sqrt{{a}^{T} \cdot {X}^{( p )} \cdot {X}^{( p ) T} \cdot a} \cdot \sqrt{{\overline{1}}^{T} \cdot \overline{1}}} . \qquad ( 6 )$$

Note that this criterion is maximized when the correlation of a with all inputs xᵢ^{(p)} is as uniform as possible. The solution to this equation can be found by:

$$\begin{matrix}\frac{\partial J ( a )}{\partial a} = {X}^{( p )} \cdot \overline{1} - {a}^{T} \cdot {X}^{( p )} \cdot \overline{1} \cdot {( {a}^{T} \cdot {X}^{( p )} \cdot {X}^{( p ) T} \cdot a \cdot {\overline{1}}^{T} \cdot \overline{1} )}^{- 1} \cdot \\ {X}^{( p )} \cdot {X}^{( p ) T} \cdot a \cdot {\overline{1}}^{T} \cdot \overline{1} \\ = 0\end{matrix} \qquad ( 7 )$$

Therefore, αX^{(p)}· 1̅=X^{(p)}·X^{(p)T}·a with

$$α = \frac{{a}^{T} \cdot {X}^{( p )} \cdot {X}^{( p ) T} \cdot a}{{a}^{T} \cdot {X}^{( p )} \cdot \overline{1}} .$$

### Furthermore,

a=α(X^{(p)}·X^{(p)T})⁻¹·X^{(p)}· 1̅,

a=α(X^{(p)}·X^{(p)T})⁻¹·X^{(p)}·X^{(p)T}′·X^{(p)}·(X^{(p)T}·X^{(p)})⁻¹· 1̅

a=αX^{(p)}·(X^{(p)T}·X^{(p)})⁻¹· 1̅. (8)

Note that α is a scalar that results in scale independent solutions. As can easily be seen, the solution EQ. (8) of the modified CCA equation of EQ. (6) is identical to the MIA solution of EQ. (2). Thus, one can argue for the equivalence of the MCCA and MIA criteria.
This new formulation of MIA is used to highlight its properties:
Corollary 3.1 The MIA equation has no solution if the inputs have zero mean, i.e. if X^{(p)}· 1̅= 0̅.
This follows from EQ. (6).
Corollary 3.2 Any combination â_{MCCA}+b with b in the nullspace of X^{(p)} is also a solution to EQ. (6).
This means that only the component of a that is in the span of X(p) contributes to the criterion in EQ. (6).
Corollary 3.3 If the N inputs X^{(p)} do not span the D-dimensional space R^{D}, then the solution of EQ. (6) is not unique.
This follows from corollary 3.2. A unique solution can be found by further constraining EQ. (6). One such constraint is that a be a linear combination of the inputs X^{(p)}:

$${\hat{a}}_{MIA} = {argmax}_{a , a = {X}^{( p )} \cdot c} \frac{{a}^{T} \cdot {X}^{( p )} \cdot \overline{1}}{\sqrt{{a}^{T} \cdot {X}^{( p )} \cdot {X}^{( p ) T} \cdot a}} . \qquad ( 9 )$$

Corollary 3.4 The MIA solution reduces to the mean of the inputs in the special case when the covariance of the data C_{XX} has one eigenvalue λ of multiplicity D, i.e. C_{XX}=λI.
Indeed, EQ. (9) can be rewritten as:

$${\hat{a}}_{MIA} = {argmax}_{a , a = {X}^{( p )} \cdot c} \frac{{a}^{T} \cdot {μ}^{( p )}}{\sqrt{{a}^{T} \cdot {C}_{XX}^{( p )} \cdot a + {( {a}^{T} \cdot {μ}^{( p )} )}^{2}}} . \qquad ( 10 )$$

After normalizing

$$a = \frac{{X}^{( p )} \cdot c}{‖ {X}^{( p )} \cdot c ‖}$$

and using the spectral decomposition theorem, it can be shown that a^{T}·C_{XX}^{(p)}·a is invariant with respect to a, given equal eigenvalues of C_{XX}^{[p]}. The function under EQ. (10) is monotonically increasing in a^{T}·μ^{(p)}. Therefore, the optimum of EQ. (10) is obtained when

$$\frac{{a}^{T} \cdot {μ}^{( p )}}{‖ a ‖}$$

is maximum. This means â_{MIA}=μ^{(p)}.

### A Bayesian MIA Framework

In this section MIA is motivated and analyzed from a Bayesian point of view. From this one can find a generalized MIA formulation that can utilize uncertainties and other prior knowledge. Furthermore, it can be shows which assumptions distinguish MIA from linear regression.

In the following, let y∈R^{D}, X∈R^{D×N}, n∈R^{D} and β∈R^{N} represent the observations, the matrix of known inputs, a noise vector and the weight parameters of interest respectively. The general linear model is defined as

y=X·β+n. (11)

Bayesian estimation finds the expectation of the random variable β given it's a priori known or estimated distribution, the signal model and observed data y. The expected value E{β|y} from the conditional probability p(β|y) can be introduced as a biased estimator of β. If n˜N(0,Cₙ) and β˜N(μ_{β},C_{β}) are independent Gaussian variables, the joint PDF p(y,β) as well as the conditional PDF p(β|y) are Gaussian. Therefore, the prior assumptions are p(y)=N(μ_{y},C_{y}) and

$$p ( y , β ) = N ( [ \begin{matrix}{μ}_{y} \\ {μ}_{β}\end{matrix} ] , [ \begin{matrix}{C}_{y} & {C}_{y β} \\ {C}_{β y} & {C}_{β}\end{matrix} ] ) .$$

Using these assumptions, the conditional probability can be computed as follows:

$$\begin{matrix}p ( β \vert y ) = \frac{p ( y , β )}{p ( y )} \\ = \frac{\frac{1}{\sqrt{{( 2 π )}^{D + N} \vert [ \begin{matrix}{C}_{y} & {C}_{y β} \\ {C}_{β y} & {C}_{β}\end{matrix} ] \vert}} exp [ \begin{matrix}\begin{matrix}- {\frac{1}{2} [ \begin{matrix}y - {μ}_{y} \\ β - {μ}_{β}\end{matrix} ]}^{T} \cdot \\ {[ \begin{matrix}{C}_{y} & {C}_{y β} \\ {C}_{β y} & {C}_{β}\end{matrix} ]}^{- 1} \cdot \end{matrix} \\ [ \begin{matrix}y - {μ}_{y} \\ β - {μ}_{β}\end{matrix} ]\end{matrix} ]}{\frac{1}{\sqrt{{( 2 π )}^{D} \vert {C}_{y} \vert}} exp [ - \frac{1}{2} {( y - {μ}_{y} )}^{T} \cdot {C}_{y}^{- 1} \cdot ( y - {μ}_{y} ) ]} .\end{matrix}$$

After a few mathematical transformations, the posterior expectation of β given y is found to become:

$$\begin{matrix}E \{ β \vert y \} = {μ}_{β} + {C}_{β} \cdot {X}^{T} \cdot {( X \cdot {C}_{β} \cdot {X}^{T} + {C}_{n} )}^{- 1} \cdot ( y - X \cdot {μ}_{β} ) , \\ = μ + {( {X}^{T} \cdot {C}_{n}^{- 1} \cdot X + {C}_{β}^{- 1} )}^{- 1} \cdot {X}^{T} \cdot {C}_{n}^{- 1} \cdot ( y - X \cdot {μ}_{β} ) .\end{matrix} \qquad \begin{matrix}( 12 ) \\ ( 13 )\end{matrix}$$

Ridge regression is a generalization of the least squares solution to regression, and follows from the result in EQ. (13) by further assuming μ_{β}= 0̅, C_{β}=σ_{β}²I, and Cₙ=σₙ²I

$${β}_{RIDGE} = {( {X}^{T} \cdot X + \frac{{σ}_{n}^{2}}{{σ}_{β}^{2}} I )}^{- 1} \cdot {X}^{T} \cdot y . \qquad ( 14 )$$

Ridge regression helps when X^{T}·X is not full rank or where there is numerical instability. During training, ridge regression assumes availability of the desired output y to aid the estimation of a non-transient weighting vector β. Thereafter, β is used to predict future outcomes of y.

Next, a Bayesian interpretation of MIA to account for uncertainties in the inputs will be discussed. Consider the following model:

r=X^{T}·w+n. (15)

The intended meaning of r is the vector of observed projections of inputs x on w, while n is measurement noise, e.g. n˜N( 0̅,Cₙ). Assume w to be a random variable. It is desired to estimate w˜N(μ_{w},C_{w}) assuming that w and n are statistically independent. Ideally, the data r=ζ 1̅ follows from the variance minimization objective if no noise is present and the variance of projections is zero, which is the MIA criterion as expressed in Theorem 2.1. A generalized MIA criterion (GMIA) may be defined by applying the derivation for EQS. (12) and (13) to model EQ. (15):

$$\begin{matrix}{w}_{GMIA} = {μ}_{w} + {C}_{w} \cdot X \cdot {( {X}^{T} \cdot {C}_{w} \cdot X + {C}_{n} )}^{- 1} \cdot ( r - {X}^{T} \cdot {μ}_{w} ) , & ( 16 ) \\ = {μ}_{w} + {( X \cdot {C}_{n}^{- 1} \cdot {X}^{T} + {C}_{w}^{- 1} )}^{- 1} \cdot X \cdot {C}_{n}^{- 1} \cdot ( r - {X}^{T} \cdot {μ}_{w} ) . & 17 )\end{matrix}$$

The GMIA solution, interpreted as a direction in a high dimensional space R^{D}, aims to minimize the difference between the observed projections r considering prior information on the noise distribution. It is an update of the prior mean μ_{w} by the current misfit r−X^{T}·μ_{w} times an input data X and prior covariance dependent weighting matrix. EQS. (16) and (17) suggest various properties of MIA and will enable one to analyze the relationship between the mean of the dataset and the solution w_{GMIA}. Note that solution EQ. (16) becomes identical to EQ. (2) if C_{w}=I, μ_{w}= 0̅ and Cₙ= 0̅. In general, it is desirable that the MIA representation is robust to small variations in X (e.g., due to noise). EQ. (16) indicates that small variations in X do not have a large effect on the GMIA result. Indeed w_{GMIA} is an invariant property of the class of inputs. Furthermore, EQS. (16) and (17) allow one to integrate additional prior knowledge such as smoothness of w_{GMIA} through the prior C_{w}, correlation of consecutive instances xᵢ through the prior Cₙ, etc. Moreover, one can use the GMIA formulation to define an iterative procedure that tackles datasets with large N and D. In such cases it might be unfeasible to compute the matrix inverse.

The difference between MIA and GMIA is, first of all, the respective models. MIA extracts a component that is equally present in all inputs (it does not model noise). GMIA relaxes the assumption that the correlations of the result with the inputs have to be equal. The GMIA model includes noise and is motivated from a Bayesian perspective. MIA is a special case of GMIA when the noise n is zero and the correlations r are assumed equal (see EQ. (15)).

### Iterative Solution

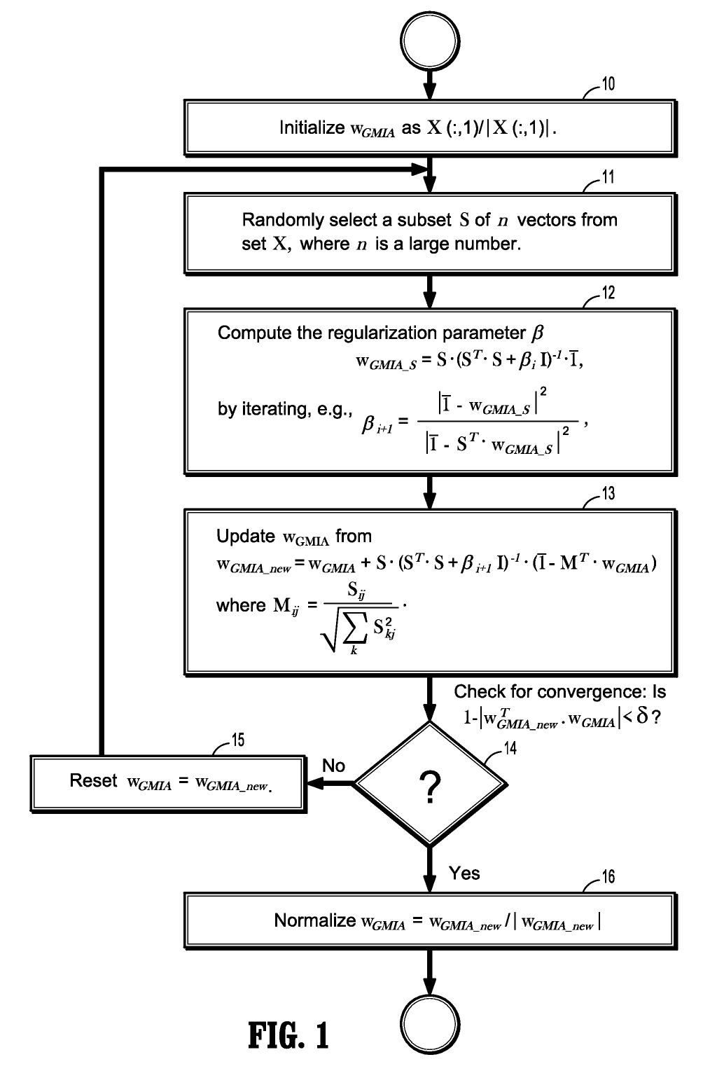

By using subsets of the input data, one can iteratively compute w_{GMIA} as a MIA representation of the whole dataset from smaller subsets. A flowchart of a method according to an embodiment of the invention for extracting an invariant representation of high dimensional data from a single class using mutual interdependence analysis (MIA) is depicted in FIG. 1. Given a set of N input vectors X of dimension D, X∈R^{D×N}, and an initialization of w_{GMIA}, one first randomly selects at step 11 a subset S of n vectors, where n, 1<n<N, is chosen large, however such that the computer system running an algorithm according to an embodiment of the invention can execute an n×n matrix inversion in a timely manner. According to an embodiment of the invention, w_{GMIA} is initialized at step 10 as

$${w}_{GMIA\_it} = \frac{X ( : , 1 )}{\vert X ( : , 1 ) \vert}$$

where X (:,1) is a first vector in the set X. Then, at step 12, one computes the regularization parameter β. One technique according to an embodiment of the invention for computing β is to first initialize β to a very small number, such as 10⁻¹⁰, then iterating

$${w}_{GMIA\_S} = S \cdot {( {S}^{T} \cdot S + {β}_{i} I )}^{- 1} \cdot \overline{1} , \\ {β}_{i + 1} = \frac{{\vert \overline{1} - {w}_{GMIA\_S} \vert}^{2}}{{\vert \overline{1} - {S}^{T} \cdot {w}_{GMIA\_S} \vert}^{2}} ,$$

until convergence of β, e.g. until |βᵢ₊₁−βᵢ|<ε, where ε is a very small positive number, such as 10⁻¹⁰. Note that this technique for estimating β is an exemplary, non-limiting heuristic, and other techniques can be derived and be within the scope of an embodiment of the invention. Next, at step 13, a updated GMIA solution is calculated. According to an embodiment of the invention, this update may be calculated as

w_{GMIA}_{_{—}}_{new}=w_{GMIA}+S·(S^{T}·S+βᵢ₊₁I)⁻¹·( 1̅−M^{T}·w_{GMIA}),

where

$${M}_{ij} = \frac{{S}_{ij}}{\sqrt{{\sum }_{k} {S}_{kj}^{2}}} .$$

Convergence is checked at step 14. According to an embodiment of the invention, one possible convergence criteria is 1−|w_{GMIA}_{_{—}}ᵢₜ_{_{—}}_{new}^{T}·w_{GMIA}_{_{—}}ᵢₜ|<δ, where δ is a very small positive number, such as 10⁻¹⁰. If the convergence criteria is not satisfied, w_{GMIA}_{_{—}}ᵢₜ is reset equal to saved as w_{GMIA}_{_{—}}ᵢₜ_{_{—}}_{new} at step 15, and steps 11, 12, 13, and 14 are repeated. Otherwise, the final result is normalized as

$${w}_{GMIA} = \frac{{w}_{GMIA\_it \_new}}{\vert {w}_{GMIA\_it \_new} \vert}$$

at step 16. The result represents a signature that is approximately equally correlated with all input vectors. The preceding steps are exemplary and non-limiting, and other implementations will be apparent to one of skill in the art and be within the scope of other embodiments of the invention.

Convergence of the above iterative procedure using subsets of the original N vectors according to an embodiment of the invention may be seen from the following argument. First, assume that there exists a vector that is equally correlated with all inputs. An initialization of w_{GMIA}_{_{—}}_{It}=w_{GMIA}_{_{—}}_{It}+S·(S^{T}·S+βᵢ₊₁I)⁻¹·(1−M^{T}·w_{GMIA}_{_{—}}_{It}) with w_{GMIA}_{_{—}}_{It}=w_{MIA} will result in a vector with direction w_{MIA} which is equally correlated to all inputs. If N≦D, w∈R^{D}, the system of equations is under determined because there are N equations in D unknowns. Therefore there exists an infinity of solutions. By using an MIA procedure according to an embodiment of the invention, the search is constrained to the space of the inputs. There is a unique solution if (X^{T}·X) is invertible. If n˜N(0,μ_{w}), then w_{MIA}=μ_{w}. This can be seen as follows:

X^{T}·w=r+n, with n˜N(0,μ_{w}) and r= 1̅;

w=X·(X^{T}·X)⁻¹·(r+n),

μ_{w}=X·(X^{T}·X)⁻¹·r+X·(X^{T}·X)⁻¹·n,

μ_{w}=w_{MIA}+ 0̅=w_{MIA}.

In general, statistical signal processing approaches assume N>D. In this case, X^{T}w=r is over determined, as there are N equations in D unknown. The unknown vector w can be found, for example, by a minimum mean square error criterion such as least squares.

### Synthetic Data Example

In this section, feature extraction is performed on synthetic data in order to interpret MIA and visualize differences between MIA, GMIA, principal component analysis (PCA), independent component analysis (ICA), and the mean. A random signal model is defined to create synthetic problems for comparing the feature extraction results to the true feature desired. Assume the following generative model for input data x:

$${x}_{1} = {α}_{1} s + {f}_{1} + {n}_{1} , \\ {x}_{2} = {α}_{2} s + {f}_{2} + {n}_{2} , \\ ⋮ \\ {x}_{N} = {α}_{N} s + {f}_{N} + {n}_{N} , \qquad ( 18 )$$

where s is a common, invariant component or feature we aim to extract from the inputs, αᵢ, i=1, . . . , N are scalars, typically all close to 1, fᵢ, i=1, . . . , N are combinations of basis functions from a given orthogonal dictionary such that any two are orthogonal and nᵢ, i=1, . . . , N are Gaussian noises. It will be shown that MIA estimates the invariant component s, inherent in the inputs x.

This model can be made precise. As before, D and N denote the dimensionality and the number of observations. In addition, K is the size of a dictionary B of orthogonal basis functions. Let B=[b₁, . . . , b_{K}] with bₖ∈R^{D}. Each basis vector bₖ is generated as a weighted mixture of maximally J elements of the Fourier basis which are not reused to ensure orthogonality of B. The actual number of mixed elements is chosen uniformly at random, Jₖ∈N and Jₖ˜(1,J). For bₖ, the weights of each Fourier basis element i are given by wⱼₖ˜N(0,1), j=1, . . . , Jₖ. For i=1, . . . , D, analogous to a time dimension, the basis functions are generated as:

$${b}_{k} ( i ) = \frac{{\sum }_{j = 1}^{{J}_{k}} {w}_{jk} sin ( \frac{2 π i {α}_{jk}}{D} + {β}_{jk} \frac{π}{2} )}{\sqrt{\frac{D}{2} {\sum }_{j = 1}^{{J}_{k}} {w}_{jk}^{2}}} , \\ with$$

$${α}_{jk} ∈ [ 1 , … , \frac{D}{2} ] ; {β}_{jk} ∈ [ 0 , 1 ] ;$$

$$[ {α}_{jk} , {β}_{jk} ] \neq [ {α}_{lp} , {β}_{lp} ] ∀ j \neq l or k \neq p .$$

In the following, one of the basis functions bₖ is randomly selected to be the common component s∈[b₁, . . . , b_{K}]. The common component is excluded from the basis used to generate uncorrelated additive functions fₙ, n=1, . . . , N. Thus only K−1 basis functions can be combined to generate the additive functions f_{n∈}R^{D}. The actual number of basis functions Jₙ is randomly chosen, i.e., similarly to Jₖ, with J=K−1. The randomly correlated additive components are given by:

$${f}_{n} ( i ) = \frac{{\sum }_{j = 1}^{{J}_{n}} {w}_{jn} {c}_{jn} ( i )}{\sqrt{{\sum }_{j = 1}^{{J}_{n}} {w}_{jn}^{2}}} ,$$

with

cⱼₙ∈[b₁, . . . , b_{K}]; cⱼₙ≠s, ∀j, n; cⱼₙ≠cₗₚ, ∀j≠l and n=p.

Note that ∥s∥=∥fₙ∥=∥nₙ∥=1, ∀n=1, . . . , N. To control the mean and variance of the norms of the common, additive and noise components in the inputs, each component is multiplied by the random variable a₁˜N(m₁,σ₁²,) a₂˜N(m₂,σ₂²) and a₃˜N(m₃,σ₃²), respectively. Finally, the synthetic inputs are generated as:

xₙ=a₁s+a₂fₙ+a₃nₙ, (19)

with Σᵢ₌₁^{D}xₙ(i)≈0. The parameters of the artificial data generation model are chosen as D=1000, K=10, J=10 and N=20. The parameters of the distributions for a₁, a₂ and a₃ are dependent on the particular experiment and are defined correspondingly.

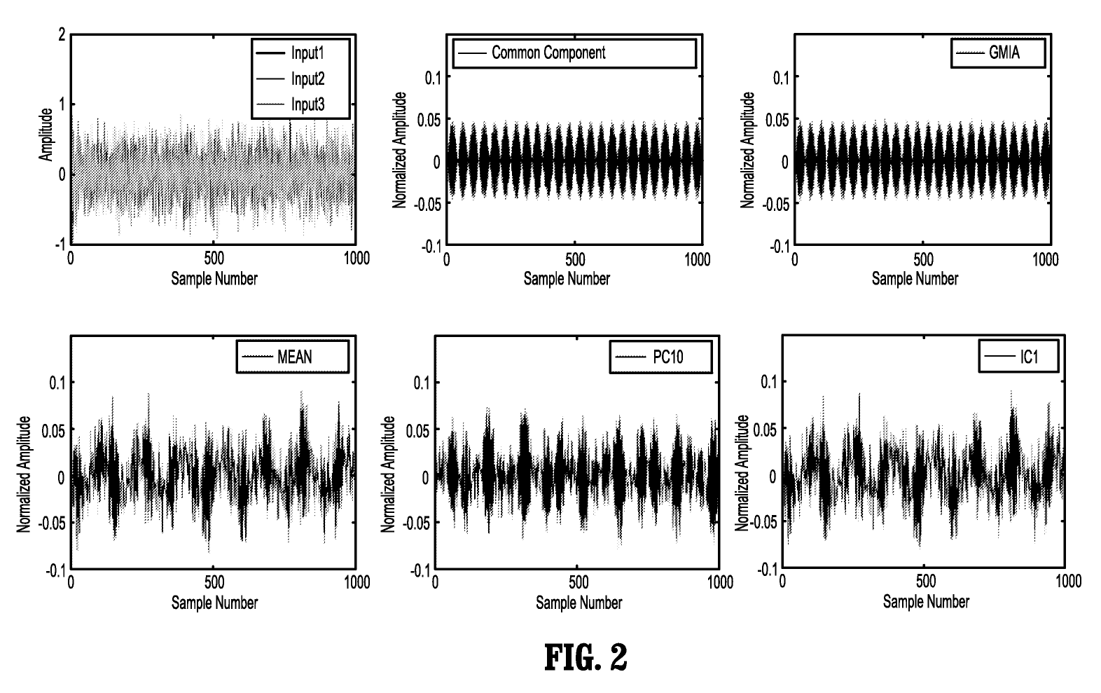

FIG. 2 depicts comparison results using various ubiquitous signal processing methods. The top left plot shows, for simplicity, only the first three inputs. The plots of principal and independent component analysis show particular components that maximally correlate with the common component s. The GMIA solution turns out to represent the common component, as it is maximally correlated to it. The GMIA solution is compared in the rightmost plot of the top row to the mean of the inputs as well as the PCA and ICA results. The mixing model parameters are chosen as m₁=1, m₂=10, m₃=0, σ₁=0.05, σ₂=0.05 and σ₃=0.05. For simplicity, the GMIA parameters are C_{w}=I, Cₙ=λI and μ_{w}= 0̅. This parameterization of GMIA by λ, the variance of the noise in EQS. (18), is denoted by GMIA(λ). Its solution represents the non regularized MIA when λ=0 and the mean of the inputs when λ→∞. That is, for λ→∞ the inverse

$${( {X}^{T} \cdot X + λ I )}^{- 1} \to \frac{1}{λ} I ,$$

simplifying the solution to

$${w}_{GMIA} \to \frac{ζ}{λ} X \cdot \overline{1} ,$$

a scaled mean of the inputs.

The tenth principal component PC10 and the first independent component IC1, were hand selected due to their maximal correlation with the common component. Over all compared methods, GMIA extracts a signature that is maximally correlated to s. All other methods fail to extract a signature as similar to the common component as GMIA.

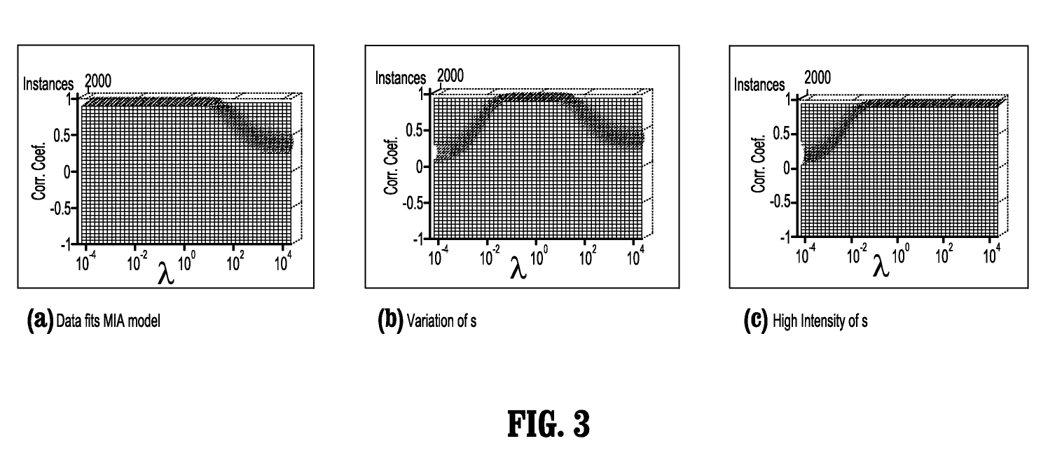

MIA, GMIA and the sample mean can be analyzed and compared in more detail by representing graphically results in a large number of randomly created synthetic problems, matching EQS. (18), for various values of the variance of nᵢ(λ). FIGS. 3(a)-(c) graphically compare the extraction performance of a common component using MIA, GMIA and the mean. The left vertical regions in the plots (λ→0) correspond to w_{GMIA}=w_{MIA}, while the right vertical regions (λ→∞) correspond to w_{GMIA}=μ, the mean of the inputs. Each point in FIG. 3 represents an experiment for a given value of λ (x-axis). The y-axis indicates the correlation of the GMIA solution with s, the true common component. The intensity of the point represents the number of experiments, in a series of random experiments, where we obtain this specific correlation value for the given λ. Overall, 1000 random experiments were performed with randomly generated inputs using various values of λ. For all test cases in FIG. 3, the weight of the additive noise is chosen as a₃˜N(0,0.0025).

There were three cases in these experiments. In FIG. 3(a), the common component intensity is invariant over the inputs and contributes little to their intensities. w_{MIA} best represents the common component. The remaining mixing model parameters are chosen as m₁=1, m₂=10, σ₁=0 and σ₂=0.05. This situation fits the MIA assumption of an equally present component with an energy one order of magnitude smaller than the residual fᵢ+nᵢ. The results show that the common component is best extracted by MIA. In FIG. 3(b), the common component intensity varies over the inputs with m₁=1, m₂=10, σ₁=0.05 and σ₂=0.05, and contributes little to their intensities. In this case, GMIA is preferable to MIA and the mean to learn a feature w_{GMIA} that is best correlated with the common component. This situation relaxes the strictly equal presence of the common component. Clearly, the simple MIA result and the mean do not represent s. However, for some λ, GMIA succeeds in extracting the common component. In FIG. 3(c), m₁=10, m₂=1, σ₁=0.05 and σ₂=0.05. Here, all inputs are similar to the common component and therefore well represented by a signal plus noise model. The mean of the inputs is a good solution to this problem.

In summary, MIA and GMIA can be used to compute efficiently features in the data representing an invariant s, or mutual feature to all inputs, whenever data fit the model of EQS. (18), even when the weight or energy of s is significantly smaller that the weight or energy of the other additive components in the model. Moreover, the computed feature w_{GMIA} is different from the mean of the data in cases like those depicted in FIGS. 3(a) and (b). The invariant feature s may have a physical interpretation of its own, depending on the problem and it is useful in determining the class membership.

### Applications of MIA

MIA can be used when it is desirable to extract a single representation from a set of high-dimensional data vectors (D≦N). Such high-dimensional data are common in the fields of audio and image processing, bioinformatics, spectroscopy etc. For example, an input image xᵢ, such as an X-ray medical grey-level image, could have 600×600 pixels, in which case D=600 when applying MIA on the collection of correspondent lines or columns between images. Possible MIA applications include novelty detection, classification, dimensionality reduction and feature extraction. In the following, the procedures used in these applications are motivated and discussed, including preprocessing and evaluation steps. Furthermore, how the data segmentation affects the performance of a GMIA-based classifier is illustrated.

### Text Independent Speaker Verification

GMIA can be applied to the problem of extracting signatures from speech data for the purpose of text-independent speaker verification. Signal quality and background noise present challenges in automated speaker verification. For example, telephone signals are nonlinearly distorted by the channel. Humans are robust to such changes in environmental conditions. MIA seeks to extract a signature that mutually represents the speaker in recordings from different nonlinear channels. Therefore, this feature represents the speaker but is invariant to the channels. Intuitively, this signature should provide a robust feature for speaker verification in unknown channel conditions.

Various portions of the NTIMIT database (Fisher et al., 1993) were used to test this intuition and compare the results to other methods. The NTIMIT database contains speech from 630 speakers that is nonlinearly distorted by real telephone channels. Each speaker is represented by 10 utterances that are subdivided into three content types: Type one represents two dialect sentences that are the same for all speakers in the database, type two contains five sentences per speaker that are in common with seven other speakers and type three includes three unique sentences. A mix of all content types was used for training and testing.

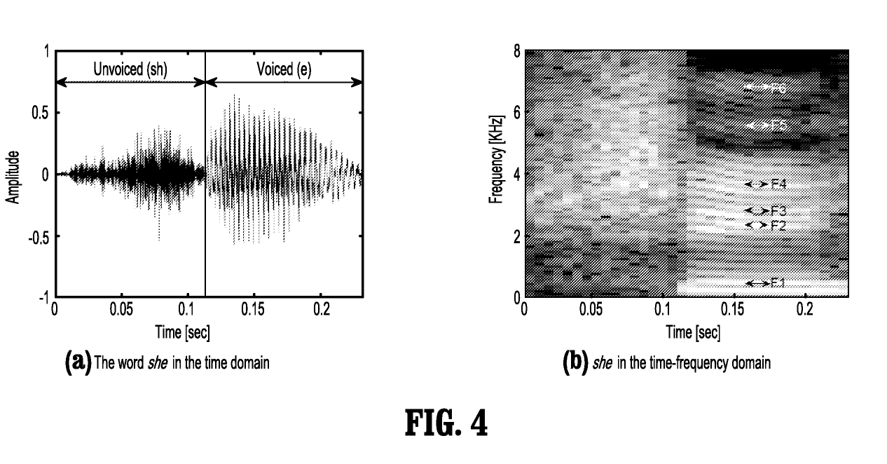

A speech signal can be modeled as an excitation that is convolved with a linear dynamic filter which represents the vocal tract. The excitation signal can be modeled for voiced speech as a periodic signal and for unvoiced speech as random noise. It is common to analyze the voiced and unvoiced speech separately to ensure that only one of those excitation types is present in each instance. A comparison of the waveform structures from voiced and unvoiced sounds is shown in FIGS. 4(a)-(b). FIG. 4(a) shows that the unvoiced part /∫/ of the word she appears like amplitude modulated noise. The voiced part /i/ has a clear periodic structure. FIG. 4(b) depicts the time frequency representation of the same waveform, which unveils the formants (F1-F6) of the voiced /i/. In contrast, the unvoiced sounds are smoothly structured over the whole frequency range lacking the horizontal line-structure of the voiced sounds. Note that there is not always such a clear boundary between the voiced and unvoiced sounds as in this example.

In this disclosure, voiced speech is used for speaker verification. Let e^{(p)}, h^{(p)} and v^{(p)} be the spectral representations of the excitation, vocal tract filter and the voiced signal parts of person p respectively. Moreover, let m represent speaker-independent signal parts in the spectral domain (e.g. recording equipment, environment, etc.). Therefore, the data can be modeled as: v^{(p)}=e^{(p)}h^{(p)}·m. By cepstral deconvolution, the model is represented as a linear combination of its basis functions, for each instance i:

xᵢ^{(p)}=log vᵢ^{(p)}=log eᵢ^{(p)}+log h^{(p)}+log mᵢ (20)

This additive model suggests that one can use MIA to extract a signature that represents the speaker's vocal tract log h^{(p)}. Several preprocessing steps are used to transform the raw data such that the additive model holds.

### Data Preprocessing

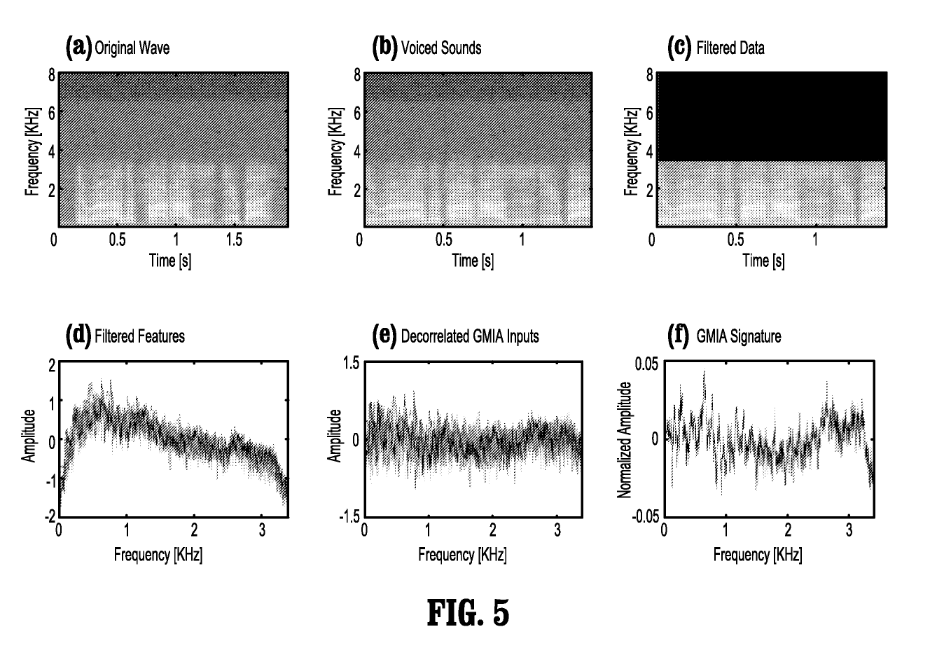

According to an embodiment of the invention, each of the utterances is preprocessed separately to prevent cross interference. The preprocessing of the audio inputs is illustrated in FIGS. 5(a)-(f). FIG. 5(a) depicts an original audio input signal. First, silence and background noise are excluded from the wave data. To achieve this, the logarithmic absolute kurtosis values for 20 ms, half overlapping data intervals are compared against an empirical threshold. If the values of more than two consecutive intervals fall below this threshold, all but the first and last interval are cut. The two retained intervals are exponentially smoothed preventing discontinuities at the cutting ends. Second, the unvoiced speech segments are eliminated using a short-time autocorrelation (STAC) like approach. Let w(k) represent a window function with nonzero elements for k=0, . . . , K−1. The STAC, which is commonly used for voiced/unvoiced speech separation, is defined as:

$${STAC}_{n} ( i ) = {\sum }_{m = - ∞}^{∞} x ( m ) w ( n - m ) x ( m - i ) w ( n - m + i ) .$$

The range of the summation is limited by the window w(k). Furthermore, STAG is even, STACₙ(i)=STACₙ(−i), and tends toward zero for |i|→K. However, this method has an inherent filter effect that uses long windows. However, short windows help ensure accurate voiced/unvoiced segmentation. Thus, according to an embodiment of the invention, a Hann windowing procedure is used that reduces this effect and prevents the convergence toward zero:

$$w ( k ) = \{ \begin{matrix}0.5 ( 1 - cos ( \frac{2 π k}{K - 1} ) ) , for 0 \leq k \leq K - 1 \\ 0 , otherwise . ,\end{matrix}$$

The modified short-time autocorrelation (MSTAC) function is given by:

$${MSTAC}_{n} ( i ) = {\sum }_{m = - ∞}^{∞} x ( m ) w ( m - n ) x ( m + i ) w ( m - n )$$

This result is computed for

$$i = - \frac{K}{2} , … , \frac{K}{2}$$

and steps in n of size

$$\frac{K}{2} .$$

Note that in contrast to the STAC, these results are not necessarily even. However, quasi-periodic signals x(m), e.g., voiced sounds, unveil their periodicity in this domain. The voiced and unvoiced segments are separated using an empirical decision function that compares the low and high frequency energies of each segment. That is, the input segment is assumed to be voiced if the low frequency energies outweigh the high frequencies and vice versa. The voiced input signals are shown in FIG. 5(b).

The NTIMIT utterances are band limited by the telephone channels used. Thus, to increase the signal-to-noise ratio, the voiced speech is downsampled to 6.8 kHz. The data are processed with various window sizes to show data segmentation effects. Each utterance is segmented separately to comply with the data model in EQS. (20). An overlap is introduced if more than half of a segment would be disregarded at the end of an utterance. This step limits the loss of signal energy for short utterances and long window sizes. The downsampled signals are shown in FIG. 5(c). The utterances are then partitioned, alternating in a training and testing set to balance the text type composition.

### Feature Extraction

The segmented voiced speech x^{(p)} is nonlinearly transformed to fit the linear model in EQS. (18). Throughout this disclosure, correlation coefficients have been used as a measure of similarity between two vectors. This measure is sensitive to outliers, and low signal values result in large negative peaks in the logarithmic domain. A nonlinear filter and offset are used, before the logarithmic transformation, to reduce the effect of these signal distortions. First, the inputs are transferred to the absolute of their Fourier representation. Second, each sample is reassigned with the maximum of its original and its direct neighboring sample values. Third, an offset is added to limit the sensitivity to low signal intensities that are affected by noise. The resulting signals are transferred to the logarithmic domain, and are shown in FIG. 5(d).

Speech has a speaker-independent characteristic with maximum energy in the lower frequencies. For extracting signatures to distinguish speakers, one may disregard information that is common between them. To do this, the mean of the original inputs of all speakers is decorrelated from them. The decorrelated GMIA inputs are those parts of the input signal that are orthogonal to the mean of all features from different people. In this way, the feature space focuses on the differences between people rather than using most energy to represent general speech information, where low frequencies are dominant. The decorrelated input signals are shown in FIG. 5(e). The new inputs are then used to compute the final GMIA signatures for each speaker, shown in FIG. 5(f).

For consistency with the artificial example, the GMIA parameters are C_{w}=I, Cₙ=λI and μ_{w}= 0̅. In this example, wGMIA takes the form

$${w}_{GMIA} = \frac{1}{λ} {( \frac{1}{λ} X \cdot {X}^{T} + I )}^{- 1} \cdot X \cdot r . \qquad ( 21 )$$

Thus, the GMIA result is a weighted sum of the high dimensional inputs. For example, a window size of 250 ms and 10 seconds of speech data result in D=1700 and N=40. In the nonlinear logarithmic space, it is not meaningful to subtract two features from each other. Therefore, the parameter λ is chosen as the smallest value that ensures positive weights. Note that in the limit (λ→∞), all weights are equal and positive. The similarity value of the test data and the learned signatures is given as the negative sum of square distances between the correspondent signatures. The possible range of the GMIA distance is [−4, 0] because ∥w_{GMIA}∥=1.

### Speaker Verification Performance Evaluation

Let P, CA, WA, IR, FAR, FRR and EER denote the number of speakers in the database, number of correctly accepted speakers, number of wrongly accepted speakers, identification rate, false acceptance rate, false rejection rate and equal error rate respectively. The IR, FAR and FRR rates are given by:

$$IR = 100 \frac{CA}{P} [ \% ] ; FRR = 100 ( \frac{P - CA}{P} ) [ \% ] ;$$

$$FAR = 100 ( \frac{WA}{P ( P - 1 )} ) [ \% ] .$$

In the speaker identification task, the identity of the speaker with the highest score is assigned to the current input. On the other hand, in speaker verification, a speaker is accepted if the score between its own and the claimed identity signature exceeds the one with a background speaker model by more than a defined threshold. In the following, this background model is taken simply as the signature of a speaker in the database that achieves the highest score with the claimant's input. Thus, multiple speakers from the database could be accepted for a single claimed identity. The error rates are computed using all possible combinations of claimant and speaker identities in the database. For simplicity, one does not simulate an open set where unknown impostors are present. Clearly, the threshold has a direct effect on the FRR and FAR. The point where both error ratios are equal, called equal error rate (EER), is a prominent evaluation criterion for verification methods.

### Experimental Results

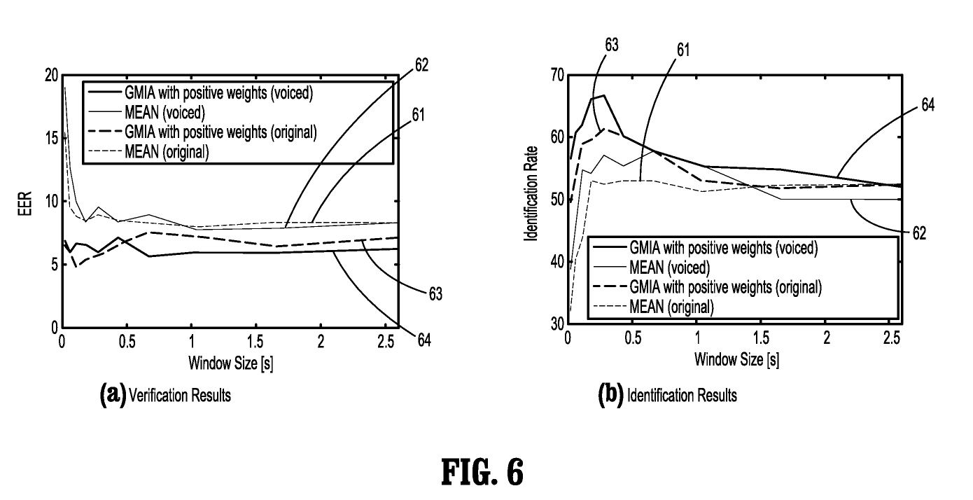

FIGS. 6(a)-(b) depicts comparison results of speaker verification results using GMIA and mean features, plotted as a function of window size. In both FIGS. 6(a) and 6(b), plot 61 represents the mean of the original inputs of all speakers, plot 62 represents the mean of the voiced parts of the inputs of all speakers, plot 63 represents the GMIA results on the original signals with positive weights, and plot 64 represents the GMIA results on the voiced signals with positive weights. Optimal performance is achieved for window lengths between 100-500 ms. FIG. 6(a) illustrates the EER results of the speaker verification approach discussed above on the NTIMIT test portion of 168 speakers, for various window sizes. GMIA clearly outperforms the mean based feature. As shown in FIG. 6(b), the performance is optimal for windows between 100-500 ms and drops sharply for shorter lengths. The results of unprocessed speech are compared to the ones using only voiced speech. The result of the mean feature is more affected than GMIA if only voiced speech is used.

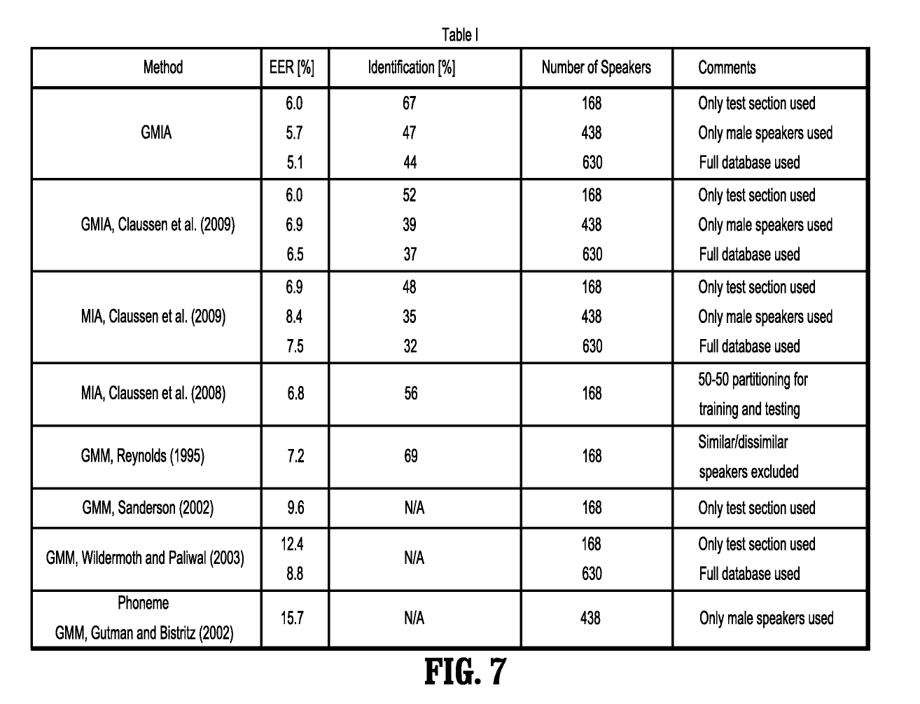

FIG. 7 shows Table 1, which presents EER results of GMIA using various NTIMIT database segments. The identification rates of the algorithms are included for comparison with previous results in the literature. Note that “GMM” indicates the standard Gaussian mixture model approach. Assumption of differently distorted inputs results in the chosen data partitioning where the utterances are alternatively separated in a training and testing set.

### Illumination Invariant Face Recognition

State-of-the-art face recognition approaches have a number of challenges, including sensitivity to multiple illumination sources and diffuse light conditions. In this section, it is shown that MIA can be used to extract illumination invariant “mutual faces” for face recognition.

### Synthetic Face Experiments

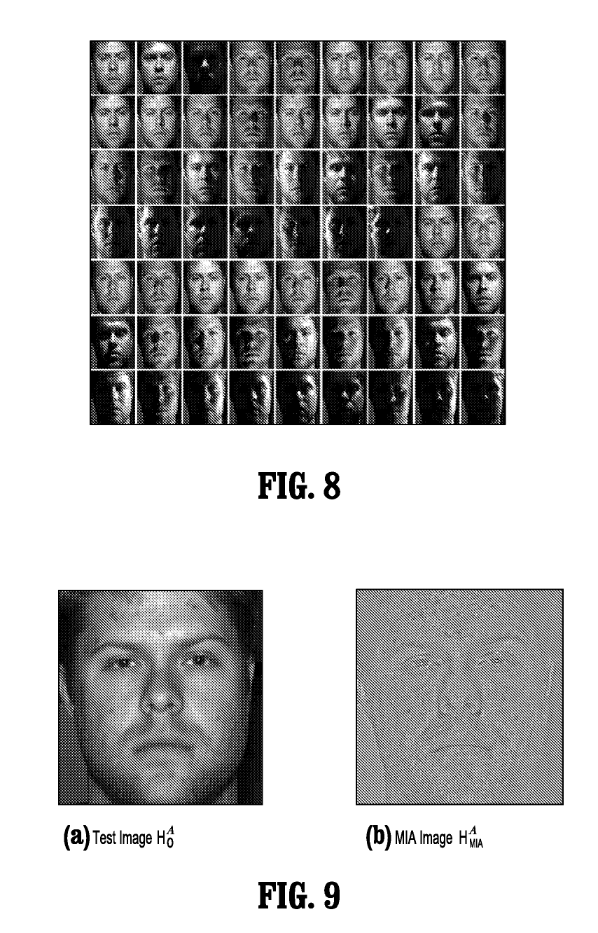

A synthetic model may be defined that allows the artificial generation of differently illuminated faces. Thus, a large number of test cases can be generated enabling a statistical analysis of MIA for face recognition. Let the face be a Lambertian object where the object image has light reflected such that the surface is observed equally bright from different angles of the observer. Then, one can assume a face image H to be a linear combination of images from an image basis Hₙ with n=1, . . . , K:

$$H = {\sum }_{n = 1}^{K} {α}_{n} {H}_{n} , \qquad ( 22 )$$

where the αₙ's are image weights. An exemplary set of basis images, to study illumination effects, is the YaleB database. This database contains 65 differently illuminated faces from 10 people and for 9 different camera angles to view a face. Each illuminated face image is obtained for a single light source at some unique but distinct position. Here, only the frontal face direction is used, but at various light source positions. The frontal illuminated faces are excluded from the basis and used as test images. Moreover, the images with ambient lighting conditions are excluded. FIG. 8 is a set of frontal images of the first person from the Yale face database B excluding the ambient and test image, that serves as the set of basis functions for the first person, A, of the YaleB database. FIGS. 9(a)-(b) shows images used for testing. FIG. 9(a) is the frontal illuminated test image H₀^{A} of the first person from the Yale face database B. FIG. 9(b) shows the mutual image that is extracted from 20 randomly generated inputs. Each input is a combination of 5 randomly selected images of a person.

Next, 20 images are synthetically generated as inputs to GMIA(λ). Each of these images is a combination of J=5 randomly selected images Hᵢ from the basis set Hₙ. The basis images are combined according to EQ. (22) using weights α˜U(0,1). To retain the image scaling:

$$H = \frac{{\sum }_{i = 1}^{J} {α}_{i} {H}_{i}}{{\sum }_{i = 1}^{J} {α}_{i}} .$$

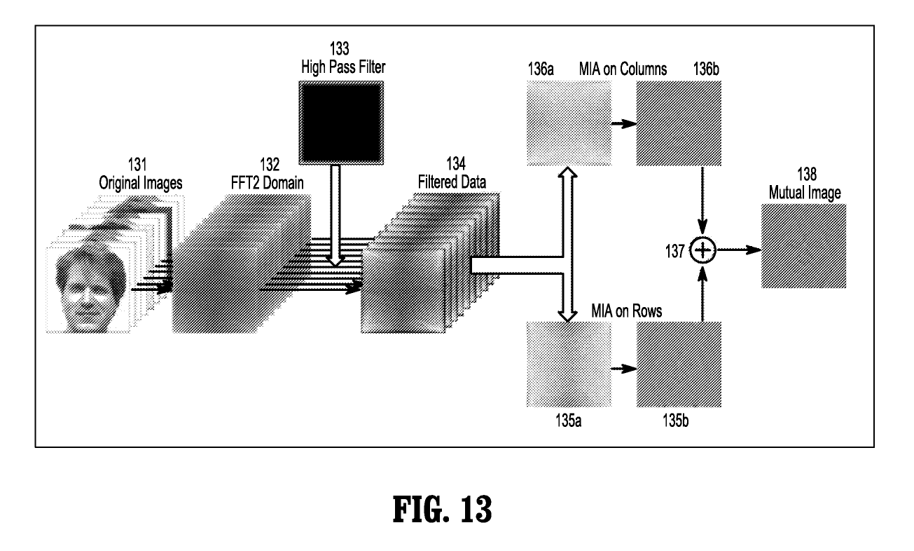

An ‘invariant’ face signature is extracted to represent each person using MIA. This process, illustrated in FIG. 13, is defined as follows. First, the original images 131 are 2D Fourier transformed 132 and filtered with a high pass filter 133 to yield filtered data 134. Thereafter, GMIA(λ) is separately computed for rows 135a-b and columns 136a-b, resulting in D=250 and N=20. In a final step 137, GMIA representations for rows and columns are added and the data is processed using an inverse 2D Fourier transform to obtain a face signature 138 of the person. This signature is called a mutual face and is, e.g., denoted H_{MIA}^{A} for person A. FIG. 9(b) illustrates a GMIA representation that is generated using this procedure.

A measure is defined to evaluate the similarity between test and GMIA images for the purpose of face recognition. First, the images are filtered on their boundary. Second, the mean correlation scores of both images are computed separately for rows ( [symbol] ₁) and columns ( [symbol] ₂). A combined score is generated as:

$$ς = \frac{\sqrt{{ς}_{1}^{2} + {ς}_{2}^{2}}}{\sqrt{2}}$$

Thus, the score is upper-bounded by the value one.

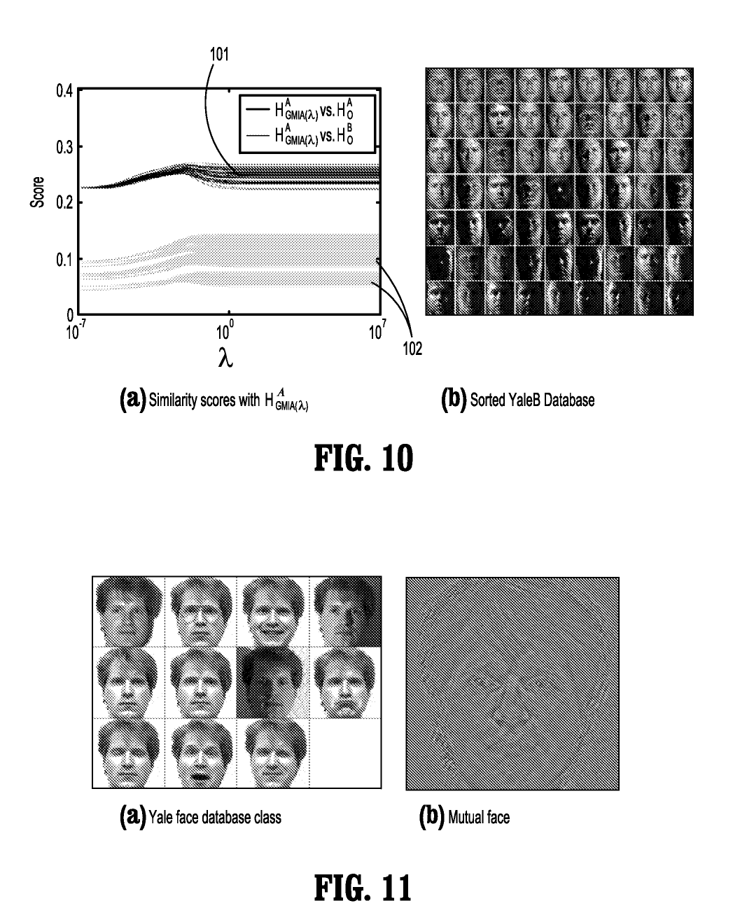

Now an MIA method according to an embodiment of the invention is tested to capture illumination invariant facial features that can aid face recognition. FIGS. 10(a)-(b) illustrate results of synthetic MIA experiments with various illumination conditions, in particular, similarity scores between GMIA(λ) representations of 50 randomly generated input sets from person A and the test images from both A and other persons B≠A. FIG. 10(a) is a graph presenting similarity scores of GMIA(λ) representation (mutual face) and the test image of the same and different people from the YaleB database in 50 random experiments, with plots 101 being comparison results of H_{GMIA(λ)}^{A} and H₀^{A}, and plots 102 being comparison results of H_{GMIA(λ)}^{A} and H₀^{B}, both as a function of λ. FIG. 10(b) depicts images of the YaleB database, ordered from high to low by their similarity score with the mutual face. MIA (for λ=0) results in an invariant image representation (all 50 scores are almost equal). Note that there is a λ-dependent trade-off between the score value and the variance. For all cases of λ, the person A scores higher than person B. FIG. 10(b) shows the training database from FIG. 8 sorted by the score with the MIA representation (mutual face) of the same person. The score becomes lower line after line from the top left to the bottom right. The mutual face achieves the highest scores with evenly illuminated images, i.e., where the illumination does not distort the image.

These results support the hypothesis that the mutual image is an illumination-invariant representation of a set of images of one person. An MIA method according to an embodiment of the invention will be used in a face recognition application described next.

### Experiments on the Yale Database

An MIA-based mutual face approach according to an embodiment of the invention was tested on the Yale face database. The difference to the YaleB database is that this earlier version includes misalignment, different facial expressions and slight variations in scaling and camera angles. By allowing these variations, an algorithm to according to an embodiment of the invention can be tested in a more realistic face recognition scenario. The image set of one individual is given, for illustration, in FIG. 11(a). The set contains 11 images of the person taken with various facial expressions and illuminations, with or without glasses. FIG. 11(b) depicts the MIA result, or mutual face estimated from all images of the set. The reflected light intensity I of each image pixel can be modeled as a sum of an ambient light component and directional light source reflections. Let Iₐ and Iₚ be the ambient/directional light source intensities. Also, let kₐ, k_{d}, n̅ and l̅ be ambient/diffuse reflection coefficients, surface normal of the object, and the direction of the light source respectively. Hence,

I=Iₐkₐ+Iₚk_{d}( n̅· l̅).

More complex illumination models including multiple directional light sources can be captured by the additive superposition of the ambient and reflective components for each light source.

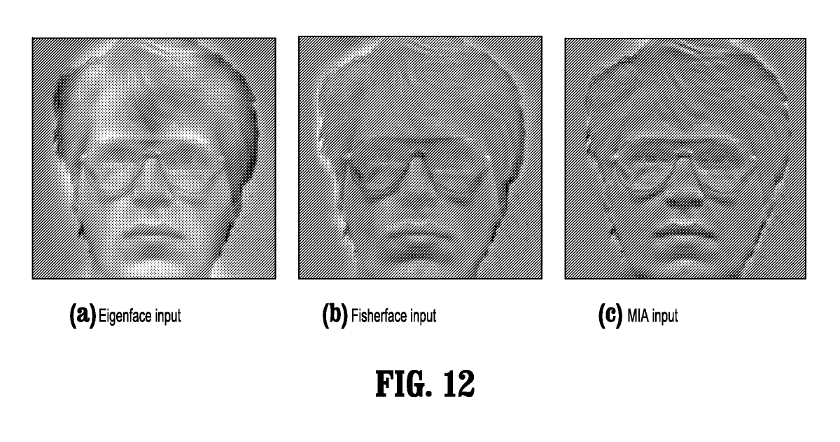

An MIA method according to an embodiment of the invention can extract an illumination-invariant mutual image, perhaps including Iₐkₐ, from a set of aligned images of the same object (face) under various illumination conditions. In the following, mutual faces were used in a simple appearance-based face recognition experiment. An MIA method according to an embodiment of the invention uses centered images (xᵢ^{T}· 1̅=0, ∀i) as inputs. FIGS. 12(a)-(c) shows examples of training instances the illustrates the difference between a mean-face-subtracted input instance in the Eigenface approach, shown in FIG. 12(a), the Fisherface approach, shown in FIG. 12(b), and a centered MIA input according to an embodiment of the invention, shown in FIG. 12(c). In FIG. 12(b), the mean-subtracted face was obtained as difference between a face instance and the mean image of all instances for the same person, while in FIG. 12(c), a “centered” face image was obtained by subtraction of the mean column value from each image column.

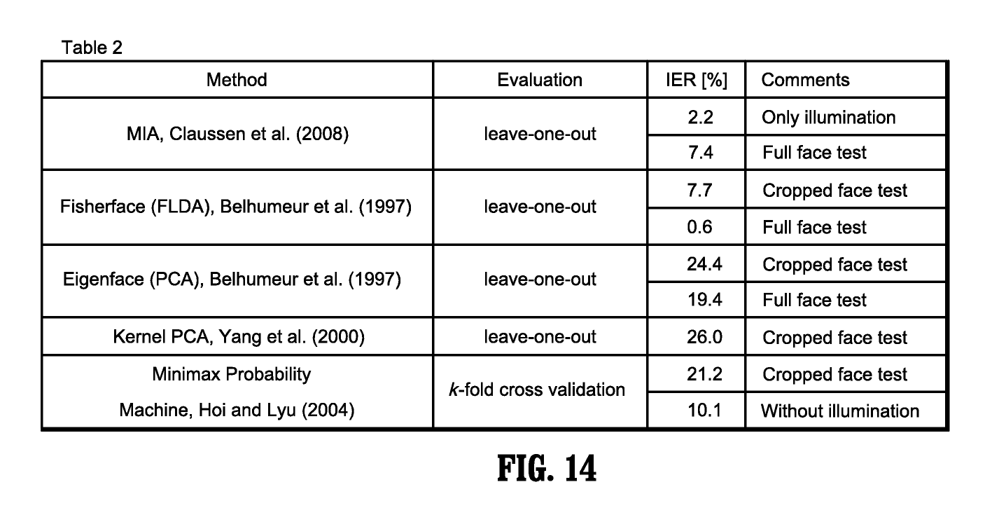

A procedure according to an embodiment of the invention to extract the mutual face from the face set of one person is discussed in the preceding section and was illustrated in FIG. 13. Face identification is performed using cropped and centered images. In addition, the measure of similarity between a test image and the MIA representation of a person is defined in the preceding section. Mutual faces are learned on all but a single test image using the “leave-one-out” method. The left-out image is one of the three illumination variant cases of the Yale database (centered light, left light and right light). This approach leads to an identification error rate (IER) of 2.2%. Overall, in exhaustive leave-one-out tests, a mutual face method according to an embodiment of the invention results in an error rate of 7.4%. Recognition performance for unknown illumination is comparable or exceeds reported results obtained with similar data, presented in Table 2 of FIG. 14, which shows, a comparison of the identification error rate (TER) of MIA with other methods using the Yale database. Full faces include some background compared to cropped images. An MIA approach according to an embodiment of the invention can be used to enhance both feature- and appearance-based methods, only requires minimal training due to its closed form solution, and appears insensitive to multiple illumination sources and diffuse light conditions.

### System Implementation

It is to be understood that embodiments of the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

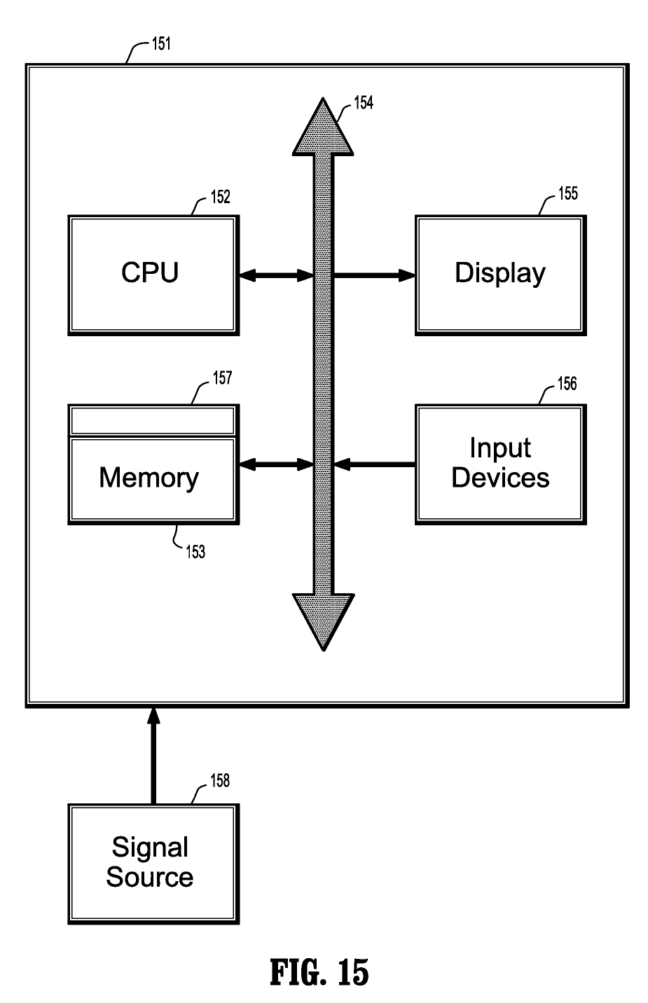

FIG. 15 is a block diagram of an exemplary computer system for implementing a method for determining an invariant representation of high dimensional instances can be extracted from a single class using mutual interdependence analysis (MIA) according to an embodiment of the invention. Referring now to FIG. 15, a computer system 151 for implementing the present invention can comprise, inter alia, a central processing unit (CPU) 152, a memory 153 and an input/output (I/O) interface 154. The computer system 151 is generally coupled through the I/O interface 154 to a display 155 and various input devices 156 such as a mouse and a keyboard. The support circuits can include circuits such as cache, power supplies, clock circuits, and a communication bus. The memory 153 can include random access memory (RAM), read only memory (ROM), disk drive, tape drive, etc., or a combinations thereof. The present invention can be implemented as a routine 157 that is stored in memory 153 and executed by the CPU 152 to process the signal from the signal source 158. As such, the computer system 151 is a general purpose computer system that becomes a specific purpose computer system when executing the routine 157 of the present invention.

The computer system 151 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

While the present invention has been described in detail with reference to a preferred embodiment, those skilled in the art will appreciate that various modifications and substitutions can be made thereto without departing from the spirit and scope of the invention as set forth in the appended claims.

What is claimed is:

1. A computer-implemented method for determining a signature vector of a high dimensional dataset, the method performed by the computer comprising the steps of:
initializing a mutual interdependence vector w_{GMIA} from a a set X of N input vectors of dimension D, wherein N≦D;
randomly selecting a subset S of n vectors from set X, wherein n is such that n>>1 and n<N;
calculating an updated mutual interdependence vector w_{GMIA} from
w_{GMIA}_{_{—}}_{new}=w_{GMIA}+S·(S^{T}·S+βI)⁻¹·( 1̅−M^{T}·w_{GMIA}),
wherein β is a regularization parameter,
$${M}_{ij} = \frac{{S}_{ij}}{\sqrt{{\sum }_{k} {S}_{kj}^{2}}} ,$$
I is an identity matrix, and 1̅ is a vector of ones; and
repeating said steps of randomly selecting a subset S from set X, and calculating an updated mutual interdependence vector until convergence, wherein said mutual interdependence vector is approximately equally correlated with all input vectors X.

2. The method of claim 1, wherein said mutual interdependence vector converges when 1−|w_{GMIA}_{_{—}}_{new}^{T}·w_{GMIA}|<δ, where δ<<1 is a very small positive number.

3. The method of claim 1, further comprising estimating said regularization parameter β by
initializing β to a very small positive number βᵢ<<1; and
repeating the steps of
setting w_{GMIA}_{_{—}}_{S}=S·(S^{T}·S+βᵢI)⁻¹· 1̅, and
calculating an updated βᵢ₊₁,
until |βᵢ₊₁−βᵢ|<ε, where ε<<1 is a positive number.

4. The method of claim 3, wherein
$${β}_{i + 1} = \frac{{\vert \overline{1} - {w}_{GMIA\_S} \vert}^{2}}{{\vert \overline{1} - {S}^{T} \cdot {w}_{GMIA\_S} \vert}^{2}} .$$

5. The method of claim 1, wherein said mutual interdependence vector w_{GMIA} is initialized as
$${w}_{GMIA} = \frac{X ( : , 1 )}{\vert X ( : , 1 ) \vert} ,$$
wherein X (:,1) is a first vector in said set X.

6. The method of claim 1, further comprising normalizing w_{GMIA} as
$$\frac{{w}_{GMIA}}{\vert {w}_{GMIA} \vert} .$$

7. The method of claim 1, wherein said D-dimensional set X of input vectors is a set of signals of a class, and said mutual interdependence vector w_{GMIA} represents a class signature.

8. The method of claim 7, wherein said class is one of an audio signal representing one person, an acoustic or vibration signal representing a device or phenomenon, or a one-dimensional signal representing a quantization of a physical or biological process.

9. The method of claim 7, further comprising:
processing the signal inputs to a domain wherein resulting signals fit a linear model xᵢ=aᵢs+fᵢ+nᵢ, wherein i=1, . . . , N, s is a common, invariant component to be extracted from said signals, αᵢ are predetermined scalars, fᵢ are combinations of basis functions selected from an orthogonal dictionary wherein any two basis functions are orthogonal, and nᵢ are Gaussian noises.

10. The method of claim 1, wherein said D-dimensional set X of input vectors is a set of two-dimensional signals, under varying illumination conditions, and said mutual interdependence vector w_{GMIA} represents a class signature.

11. A computer-implemented method for determining a signature vector of a high dimensional dataset, the method performed by the computer comprising the steps of:
providing a set of N input vectors X of dimension D, X∈R^{D×N}, wherein N<D;
calculating a mutual interdependence vector w_{GMIA} that is approximately equally correlated with all input vectors X from
$$\begin{matrix}{w}_{GMIA} = {μ}_{w} + {C}_{w} \cdot X \cdot {( {X}^{T} \cdot {C}_{w} \cdot X + {C}_{n} )}^{- 1} \cdot ( r - {X}^{T} \cdot {μ}_{w} ) , \\ = {μ}_{w} + {( X \cdot {C}_{n}^{- 1} \cdot {X}^{T} + {C}_{w}^{- 1} )}^{- 1} \cdot X \cdot {C}_{n}^{- 1} \cdot ( r - {X}^{T} \cdot {μ}_{\cdot w} ) ,\end{matrix}$$
wherein r is a vector of observed projections of inputs x on w wherein r=X^{T}·w+n, n is a Gaussian measurement noise, with 0 mean and covariance matrix Cₙ, w is a Gaussian distributed random variable with mean μ_{w} and covariance matrix Cₙ and w and n are statistically independent.

12. The method of claim 11, comprising iteratively computing μ_{w} as an approximation to w_{GMIA} using subsets S of the set X of input vectors.

13. A program storage device readable by a computer, tangibly embodying a program of instructions executable by the computer to perform the method steps for determining a signature vector of a high dimensional dataset, the method comprising the steps of:
initializing a mutual interdependence vector w_{GMIA} from a a set X of N input vectors of dimension D, wherein N≦D;
randomly selecting a subset S of n vectors from set X, wherein n is such that n>>1 and n<N;
calculating an updated mutual interdependence vector w_{GMIA} from
w_{GMIA}_{_{—}}_{new}=w_{GMIA}+S·(S^{T}·S+βI)⁻¹·( 1̅−M^{T}·w_{GMIA}),
wherein β is a regularization parameter,
$${M}_{ij} = \frac{{S}_{ij}}{\sqrt{{\sum }_{k} {S}_{kj}^{2}}} ,$$
I is an identity matrix, and 1̅ is a vector of ones; and
repeating said steps of randomly selecting a subset S from set X, and calculating an updated mutual interdependence vector until convergence, wherein said mutual interdependence vector is approximately equally correlated with all input vectors X.

14. The computer readable program storage device of claim 13, wherein said mutual interdependence vector converges when 1−|w_{GMIA}_{_{—}}_{new}^{T}·w_{GMIA}|<δ, where δ<<1 is a very small positive number.

15. The computer readable program storage device of claim 13, the method further comprising estimating said regularization parameter β by
initializing β to a very small positive number βᵢ<<1; and
repeating the steps of
setting w_{GMIA}_{_{—}}_{S}=S·(S^{T}·S+βᵢI)⁻¹· 1̅, and
calculating an updated βᵢ₊₁,
until |βᵢ₊₁−βᵢ|<ε, where ε<<1 is a positive number.

16. The computer readable program storage device of claim 15, wherein
$${β}_{i + 1} = \frac{{\vert \overline{1} - {w}_{GMIA\_S} \vert}^{2}}{{\vert \overline{1} - {S}^{T} \cdot {w}_{GMIA\_S} \vert}^{2}} .$$

17. The computer readable program storage device of claim 13, wherein said mutual interdependence vector w_{GMIA} is initialized as
$${w}_{GMIA} = \frac{X ( : , 1 )}{\vert X ( : , 1 ) \vert} ,$$
wherein X (:,1) is a first vector in said set X.

18. The computer readable program storage device of claim 13, the method further comprising normalizing w_{GMIA} as
$$\frac{{w}_{GMIA}}{\vert {w}_{GMIA} \vert} .$$

19. The computer readable program storage device of claim 13, wherein said D-dimensional set X of input vectors is a set of signals of a class, and said mutual interdependence vector w_{GMIA} represents a class signature.

20. The computer readable program storage device of claim 19, wherein said class is one of an audio signal representing one person, an acoustic or vibration signal representing a device or phenomenon, or a one-dimensional signal representing a quantization of a physical or biological process.

21. The computer readable program storage device of claim 19, the method further comprising:
processing the signal inputs to a domain wherein resulting signals fit a linear model xᵢ=aᵢs+fᵢ+nᵢ, wherein i=1, . . . , N, s is a common, invariant component to be extracted from said signals, αᵢ are predetermined scalars, fᵢ are combinations of basis functions selected from an orthogonal dictionary wherein any two basis functions are orthogonal, and nᵢ are Gaussian noises.

22. The computer readable program storage device of claim 13, wherein said D-dimensional set X of input vectors is a set of two-dimensional signals, under varying illumination conditions, and said mutual interdependence vector w_{GMIA} represents a class signature.
